(19) United States
(12) Patent Application Publication
(10) Pub. No.: US 2013/0219280 A1
(43) Pub. Date: Aug. 22, 2013

(54) Systems and Methods for Software Evaluation in a Cloud Computing Environment

(71) Applicant: Numira Biosciences, (US)

(72) Inventors: David WEINSTEIN, Salt Lake City, UT (US); Neha Shah, Salt Lake City, UT (US)

(73) Assignee: Numira Biosciences, Salt Lake City, UT (US)

(21) Appl. No.: 13/771,002

(22) Filed: Feb. 19, 2013

Related U.S. Application Data
(60) Provisional application No. 61/600,533, filed on Feb. 17, 2012.

(51) Int. Cl. H04L 29/06

(52) U.S. Cl. CPC H04L 65/1069
USPC 715/736

(57) ABSTRACT

System and methods for software evaluation in a cloud computing environment are disclosed. In some implementations, a method includes: at a computer system, maintaining session information for a plurality of remote user sessions between one or more users and the computer system and formatting for display a plurality of graphical representations corresponding to the plurality of remote user sessions. A respective graphical representation in the plurality of graphical representations indicates a current or historical state of a corresponding remote user session, in the plurality of remote user sessions. The method further includes obtaining a user selection of a graphical representation in the plurality of graphical representations. In response to user selection of the graphical representation, a session is established between a client device associated with the user and the computer system and the session is initiated in the state as indicated in the graphical representation.

### TECHNICAL FIELD

The present application relates generally to systems and methods for managing, viewing, using, demonstrating, and showcasing software applications provided by a sponsor, in which users can access the software applications in a cloud computing environment.

### BACKGROUND

Software applications are created, marketed, and sold to individuals or companies for entertainment, productivity, or to solve business tasks or other objectives. Various industries require and use custom designed software applications to aid in business growth or to simplify business tasks. Software developers customize software applications for different industries and for different users to meet the needs of potential customers. These software applications can be so highly customized and specialized that it can be difficult to disseminate such applications and attract potential customers. However, given the rapid growth, development and innovation within the software programming field, it is becoming increasing important that software developers be able to showcase their software applications in a convenient forum.

Currently, to test or demo a software application, a user needs to purchase the software application or receive a temporary license from the developer. Once purchased or otherwise licensed, the user needs to download or otherwise install the software application on a local user system. Failing that, a user must resort to reviews and summaries of the software application created by others in order to determine whether the software application would benefit the user or the user's organization. For example, if a user wishes to purchase a software application from iTunes, the user must make a determination as to whether to purchase the software application based upon screen shots of the software application and user reviews.

### SUMMARY

As mentioned above, when a user or a company is considering purchasing a software application, the user or company may download and install the software application on a local computer system on a temporary basis. Yet setting up a software program on the user's own local system is becoming increasing complex. Software applications increasing are relying on a number of components in order to run properly. For example, dynamic-link libraries, local and remote databases, browser plug-ins, interpreters (e.g., PERL interpreter, JAVA interpreter, etc.), and complex licensing enforcement mechanisms. So, to demo many software applications, a user must faithfully install each of these required components of the software application. Moreover, some software applications only run on specific hardware or within specific operating systems that the user does not have.

Unfortunately, there is currently no platform that allows a potential customer to demo a software application without setting up the software application on the user's own local system. As such, companies wishing to showcase software applications currently do not have an infrastructure or platform for such activities. Cloud usage is in early stages, and there is currently no infrastructure or interface between software developers and potential customers. To showcase software applications, software developers are often limited to providing screen shots, summaries, testimonials from prior customers or users, and reviews if the user is unable or unwilling to run a demo of the software application or the software developer is unable or unwilling (e.g., for piracy concerns) to provide such a demo of the software application. However, it will be appreciated that, if a software developer could allow a user or potential customer to test drive the software application while maintaining control over potential piracy and without requiring the user to install the software application on their local system, this would meet the needs of developers in the software field.

Given the above background, a platform for allowing users to evaluate and run software applications without any requirement that such software applications be installed onto the users' local systems is needed.

The present disclosure addresses the shortcomings found in the prior art. In the present disclosure a runtime system having any combination of the following features is provided: (i) a login page that allows a user to log in to the runtime system, (ii) a home page, that allows the user to see information associated with a sponsor of the runtime system, (iii) an application panel that includes a synopsis of each software application in a plurality of software applications that the host of the runtime system is presently offering and, when the user selects a first software application in the plurality of software applications, provides more detail regarding the first software application and allows the user to execute the software application from within a virtual machine associated with the runtime system, (iv) an annotation module that allows the user to add annotations to an object or an instance of a software application in the plurality of software applications within the runtime system, (v) a data/sessions panel that allows the user to review all of the data sets that the user has uploaded into the runtime system, (vi) a discussion/notes board that allows a the user to track each annotations made by the to an instance of a software application in the plurality of software applications, and (vii) a data/sessions panel that allows a user to review each data set that the user has uploaded into the runtime system.

In some implementations, a method for evaluating software in a cloud environment includes, at a computer system, maintaining session information for a plurality of remote user sessions between one or more users and the computer system and formatting for display a plurality of graphical representations corresponding to the plurality of remote user sessions. A respective graphical representation in the plurality of graphical representations indicates a current or historical state of a corresponding remote user session in the plurality of remote user sessions. The method further comprises obtaining a user selection of a graphical representation in the plurality of graphical representations and, in response to the user selection of the graphical representation, (i(establishing a session between a client device associated with the user and the computer system and (ii) beginning the session in the current or historical state indicated in the graphical representation.

In some implementations, the method further includes enabling the user to execute a software application in a plurality of software applications hosted at the computer system within a virtual machine associated with the computer system.

In some implementations, a respective graphical representation represents a state in the corresponding session was terminated.

In some implementations, a respective graphical representation represents a state in the corresponding session was checkpointed.

In some implementations, the method further includes preparing for display a user interface control configured to upload data sets from the client device associated with the user for execution in a remote user session in the plurality of remote user sessions.

In some implementations, the method further includes preparing for display information identifying one or more data sets that the user has uploaded onto the computer system.

In some implementations, the method further includes preparing for display a user interface control configured to upload data sets from the client device associated with the user for execution in a remote user session in the plurality of remote user sessions.

In some implementations, the method further includes preparing for display an authentication module configured to authenticate a user before enabling the user to log in to the computer system.

In some implementations, the method further includes preparing for display an annotation module configured to enable the user to add annotations to an object or an instance of a software application in a plurality of software applications hosted at the computer system.

In some implementations, the method further includes preparing for display an annotation tracking module configure to enable the user to track one or more annotations made by the user to an instance of a software application in the plurality of software applications.

In some implementations, the method further includes preparing for display a synopsis of a software application in a plurality of software applications hosted by the computer system.

In some implementations, a system for evaluating software in a cloud environment includes one or more processing units and one or more programs including instructions, configured to be executed by the one or more processing units. The instructions are for maintaining session information for a plurality of remote user sessions between one or more users and the computer system. The instructions are further for formatting for display a plurality of graphical representations corresponding to the plurality of remote user sessions. A respective graphical representation in the plurality of graphical representations indicates a current or historical state of a corresponding remote user session, in the plurality of remote user sessions. The instructions are further for obtaining a user selection of a graphical representation in the plurality of graphical representations and, in response to the user selection of the graphical representation, (i) establishing a session between a client device associated with the user and the computer system and (ii) beginning the session in the state as indicated in the graphical representation.

In some implementations, the one or more programs included in the system further comprise instructions for enabling the user to execute a software application in a plurality of software applications hosted at the computer system within a virtual machine associated with the computer system.

In some implementations, a respective graphical representation represents a state in the corresponding session was terminated.

In some implementations, a respective graphical representation represents a state in the corresponding session was checkpointed.

In some implementations, the one or more programs included in the system further comprise instructions for preparing for display a user interface control configured to upload data sets from the client device associated with the user for execution in a remote user session in the plurality of remote user sessions.

In some implementations, the one or more programs included in the system further comprise instructions for preparing for display information identifying one or more data sets that the user has uploaded onto the computer system.

In some implementations, the one or more programs included in the system further comprise instructions for preparing for display a user interface control configured to upload data sets from the client device associated with the user for execution in a remote user session in the plurality of remote user sessions.

In some implementations, the one or more programs included in the system further comprise instructions for: preparing for display an authentication module configured to authenticate a user before enabling the user to log in to the computer system.

In some implementations, the one or more programs included in the system further comprise instructions for preparing for display an annotation module configured to enable the user to add annotations to an object or an instance of a software application in a plurality of software applications hosted at the computer system.

In some implementations, the one or more programs included in the system further comprise instructions for preparing for display an annotation tracking module configure to enable the user to track one or more annotations made by the user to an instance of a software application in the plurality of software applications.

In some implementations, the one or more programs included in the system further comprise instructions for preparing for display a synopsis of a software application in a plurality of software applications hosted by the computer system.

In some implementations, a non-transitory computer readable storage medium storing one or more programs is provided. The one or more programs comprise instructions, configured to be executed by a computer system with one or more processors, for: maintaining session information for a plurality of remote user sessions between one or more users and the computer. In some implementations, the one or more programs stored on the non-transitory computer readable storage medium further comprise instructions for enabling the user to execute a software application in a plurality of software applications hosted at the computer system within a virtual machine associated with the computer system.

In some implementations, a respective graphical representation represents a state in the corresponding session was terminated.

In some implementations, a respective graphical representation represents a state in the corresponding session was checkpointed.

In some implementations, the one or more programs stored on the non-transitory computer readable storage medium further comprise instructions for preparing for display a user interface control configured to upload data sets from the client device associated with the user for execution in a remote user session in the plurality of remote user sessions.

In some implementations, the one or more programs stored on the non-transitory computer readable storage medium further comprise instructions for preparing for display information identifying one or more data sets that the user has uploaded onto the computer system.

In some implementations, the one or more programs stored on the non-transitory computer readable storage medium further comprise instructions for preparing for display a user interface control configured to upload data sets from the client device associated with the user for execution in a remote user session in the plurality of remote user sessions.

In some implementations, the one or more programs stored on the non-transitory computer readable storage medium further comprise instructions for preparing for display an authentication module configured to authenticate a user before enabling the user to log in to the computer system.

In some implementations, the one or more programs stored on the non-transitory computer readable storage medium further comprise instructions for preparing for display an annotation module configured to enable the user to add annotations to an object or an instance of a software application in a plurality of software applications hosted at the computer system.

In some implementations, the one or more programs stored on the non-transitory computer readable storage medium further comprise instructions for preparing for display an annotation tracking module configured to enable the user to track one or more annotations made by the user to an instance of a software application in the plurality of software applications.

In some implementations, the one or more programs stored on the non-transitory computer readable storage medium further comprise instructions for preparing for display a synopsis of a software application in a plurality of software applications hosted by the computer system.

### BRIEF DESCRIPTION OF THE DRAWINGS

FIG. 1 illustrates a view of a system in accordance with the present disclosure.

FIG. 2 illustrates another view of the system in accordance with some embodiments of the present disclosure.

FIG. 3 illustrates a log in screen for a runtime system in accordance with some embodiments of the present disclosure.

FIG. 4 illustrates a home page for the host of the runtime system, showing upcoming events, the latest news and other updates associated with the host, in accordance with some embodiments of the present disclosure.

FIG. 5 illustrates a synopsis of each of the software applications that the host of the runtime system is presently offering in accordance with some embodiments of the present disclosure.

FIG. 6 illustrates a description of a selected software application that the host of the runtime system is offering licensing rights to, the description including whether the software application has been licensed, the sponsor's contract number, and features of the software application and snapshots of instances of the software application being run, in accordance with some embodiments of the present disclosure.

FIG. 7 illustrates an instance of a selected software application running in a virtual machine after the software application has been selected for trial execution by the user, with the user having the ability to upload a dataset into the runtime system and thereby into the selected software application in accordance with some embodiments of the present disclosure.

FIG. 8 illustrates the selected software application illustrated in FIG. 7 after a dataset has been uploaded into the software application by the runtime system, in accordance with some embodiments of the present disclosure.

FIG. 9 illustrates how a user can add annotation to objects or software applications within the runtime system, in accordance with some embodiments of the present disclosure.

FIG. 10 illustrates how a user can click on the data/sessions tab to review all of the data sets that the user has uploaded into the runtime system, thereby allowing the user to more easily try out the different data sets using the various software application available on the runtime system, and the figure further illustrates how the user can collect sessions, where a session is created any time when a user is running an instance of the software applications offered on the runtime system and then terminates the instance in accordance with some embodiments of the present disclosure.

FIG. 11 illustrates how a user may concurrently run several software applications to be evaluated within a single session with the runtime system and use an interface provided by the runtime system to scroll between executed instances of the several applications in accordance with some embodiments of the present disclosure.

FIG. 12 illustrates how a user can share the active runtime system screen with other users that can log into the runtime system, specifically, FIG. 12 illustrates how the user can use a menu to see who is logged into the runtime system, invite them to share the user's screen, and then run one or more software application within the runtime system such that, as the user runs the software application, the invited colleagues that accepted the invitation are able to see the same view that the inviting user has on their own local computer systems as well, in accordance with some embodiments of the present disclosure.

FIG. 13 illustrates a discussion/notes board associated with the user of the runtime system, which tracks all the annotations made by a user on any object associated with the user including, but not limited to, uploaded data and instances of software applications that have been run by the user and saved as sessions in accordance with some embodiments of the present disclosure.

FIG. 14 illustrates a second software application that is provided by the host of the runtime system that users may run in a virtual machine within the runtime system in accordance with some embodiments of the present disclosure.

Like reference numerals refer to corresponding parts throughout the several views of the drawings.

### DETAILED DESCRIPTION

The present disclosure addresses the above-identified drawbacks. Disclosed is a cloud base runtime system in which there is no requirement that a user of the runtime system run applications or software on their local computer system. As used herein, a “cloud” refers to virtual machines that are run in either public clouds (e.g. AMAZON's and MICROSOFT's cloud products) or private clouds, which typically reside in a company's own data center. Cloud application services, also known as software as a service (SaaS), provide access to software applications running remotely over the Internet, eliminating the need for the client to install and run the software applications on their local computer system. Cloud platform services, also known as platform as a service (PaaS), deliver a computing platform and/or solution stack as a service, which requires consuming cloud infrastructure and sustaining cloud software applications.

The disclosed runtime system is a cloud-based platform in which software applications that are available for evaluation can be run remotely in the cloud, and the user interacts with software application through a browser or other remote communication application running on their local computer system, iPad, or other mobile device. This eliminates the need for users to download, install, or learn how to use all the complexities of the software applications being evaluated. Thus, the disclosed runtime system delivers a significant innovation—the ability to use a cloud framework to dramatically simplify the process of running software applications for evaluation purposes in a cloud computing environment such that there is no longer a need for the user to install the software application on the user's local system in order to evaluate the software.

Organization and varied views. Once logged in to the runtime system of the present disclosure, a user can navigate to various software applications offered by the runtime system for evaluation. As disclosed in further detail below, the runtime system is configured to integrate several software applications available for evaluation from single or multiple developers, and can also integrate third party software applications for synergistic effects. In this way, the host operating the runtime system can integrate correspondence, statistical analysis, side-by-side comparisons, discussion/notes, a reference library, and other tools to aid in use of the software applications to provide potential customers with a comprehensive view of the software applications being offered for evaluation, purchase, and/or licensing.

Data incorporation. Another feature of the runtime systems of the present disclosure is their ability to organize and manage large collections of data files. For cases in which a software application can process, store, or analyze data sets, the runtime system can integrate test data for such software applications such that potential customers can upload their private data sets to run with the software applications to be evaluated. In this way, the user is able to fully access and to fully interact with select features of the software application to be evaluated, thereby gaining a more in depth evaluation of the software applications.

Integration with other applications. In some embodiments, the cloud-based runtime systems of the present disclosure offer a suite of software applications that one or more software developers desire to showcase to potential clients. These software applications may include both those that are privately developed and those developed by other vendors. Rather than purchasing servers, software, data-center space, network equipment and other hardware necessary to run such applications, potential clients instead can buy a subscription to the runtime system, or be given free access. This advantageous feature alleviates the need to download, install, operate, and manage the disparate requirements of the numerous software applications available for evaluation on the runtime system.

Increases control. A benefit of the runtime systems of the present disclosure is that they allow for an increase in control over the software applications that are being offered for evaluating, purchase, or licensing. Updates or newer versions of the software applications can easily be uploaded to the runtime system so that potential customers can have access to the latest and most current versions of the software programs to be evaluated. The software developer can easily provide updates and release newer versions by uploading and installing the software applications to a single contact point—the runtime system—instead of contacting every potential client and having such potential clients install the software on their local computer systems.

Controlled access and credentials. In a runtime system in accordance with the present disclosure, a user logs into the runtime system via an internet website or by other remote means and thereby has access to restricted and unrestricted applications and data sets based upon the user's specific credentials. This is advantageous because the use of credentials gives the host of the runtime system yet another way to control the user experience.

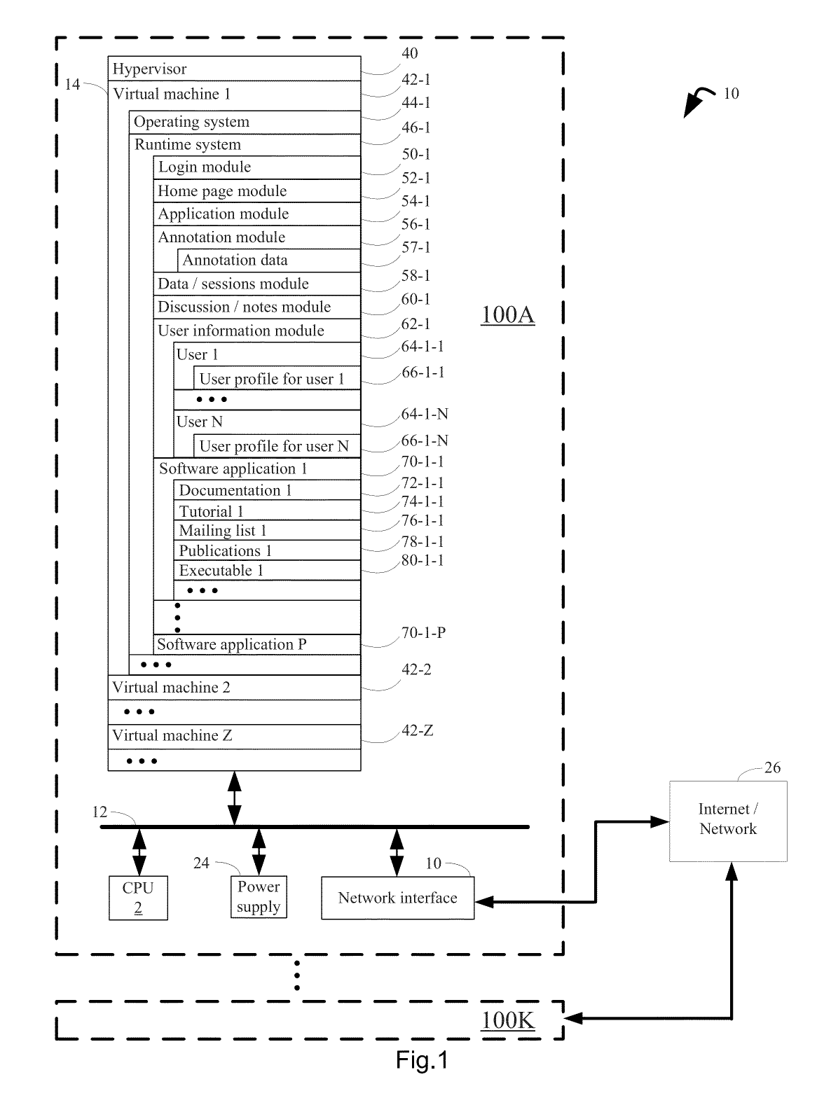

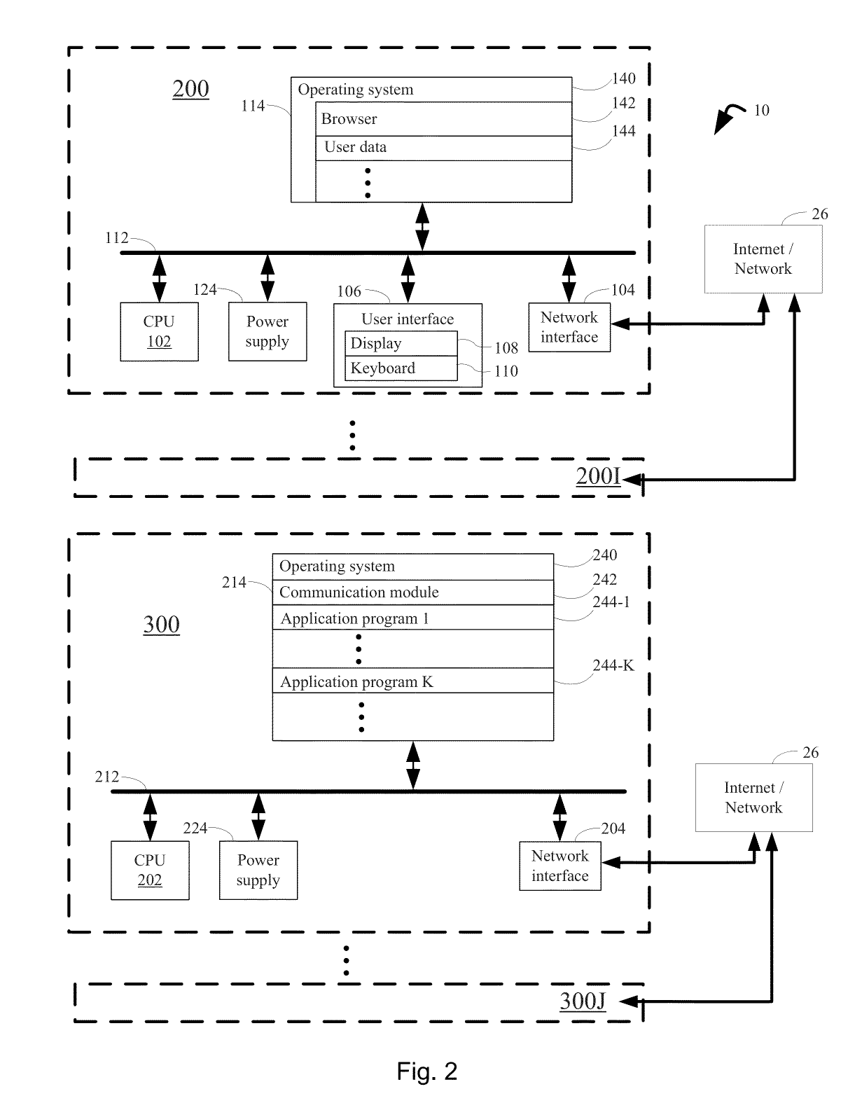

Now that an overview of the features of the runtime system have been disclosed, a detailed description of a system topology 10 in accordance with the present disclosure is described in conjunction with FIGS. 1 and 2. In the topology, there is one or more server computer 100 hosting virtual machines (FIG. 1), one or local client systems 200 (FIG. 2) and, optionally, one or more back-end servers 300 (FIG. 2). Of course, other topologies are possible, for instance, there may be any number of server computers like that of the server computer 100 collectively functioning in the same manner as the server computer 100. Moreover, more typically, there are tens, hundreds, thousands, or even thousands of local client systems 200 or more. Also, optionally, there can be any number of backend servers 300. The exemplary topology shown in FIGS. 1 and 2 merely serves to describe the features of an embodiment of the present disclosure in a manner that will be readily understood to one of skill in the art.

The server computer 100 will typically have one or more processing units (CPU's) 2, a network or other communications interface 10, a memory 14, one or more communication busses 12 for interconnecting the aforementioned components, and a power supply 24 for powering the aforementioned components. The communication busses 12 may include circuitry (sometimes called a chipset) that interconnects and controls communications between system components. Memory 14 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 14 optionally includes one or more storage devices remotely located from the CPU(s) 2. Memory 14, or alternately the non-volatile memory device(s) within memory 14, comprises a non-transitory computer readable storage medium. Memory 14 can include mass storage that is remotely located with respect to the central processing unit(s) 2. In other words, some data stored in memory 14 may in fact be hosted on computers that are external to the server computer 100 but that can be electronically accessed by the server computer 100 over an Internet, intranet, or other form of network or electronic cable (illustrated as element 26 in FIG. 1) using network interface 10.

Memory 14 preferably stores a hypervisor 40 for initiating hardware virtual machines 42 and one or more hardware virtual machines 42. There may be any number of hardware virtual machines 42 running on the server computer 100. In some instances, there is only one hardware virtual machine 42 running on the server computer 100. In some instances, there are two or more, three or more, five or more, or ten or more hardware virtual machines 42 running on the server computer 100. In some instances, a single virtual machine 42 is running on multiple server computers 100. Each respective hardware virtual machine 42 preferably comprises: an operating system 44 that includes procedures for handling various basic system services and a runtime system 46.

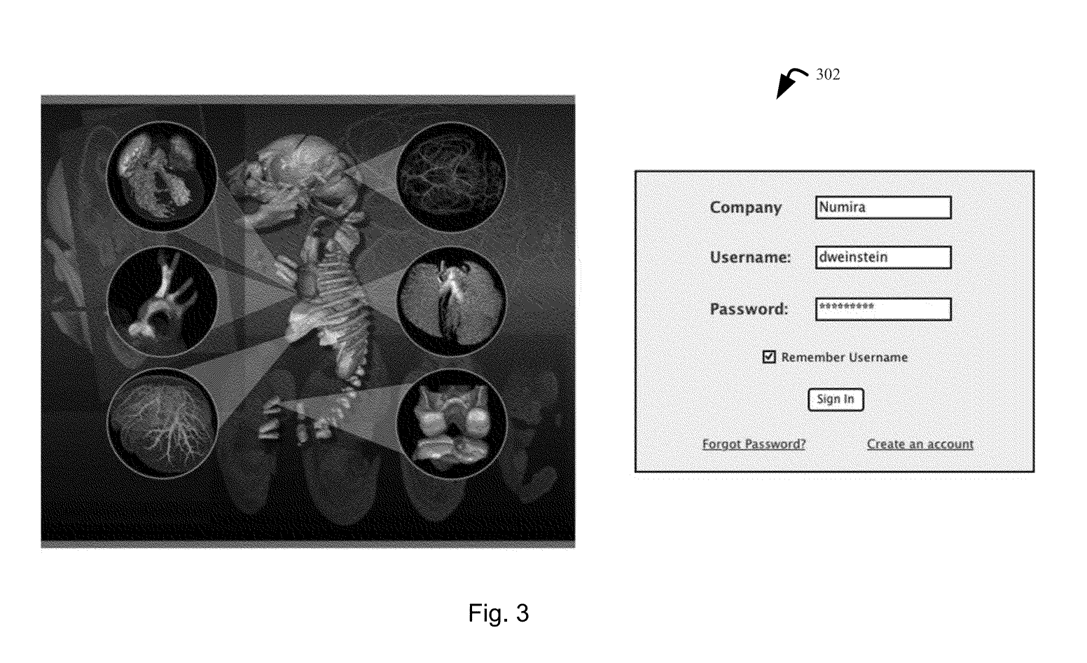

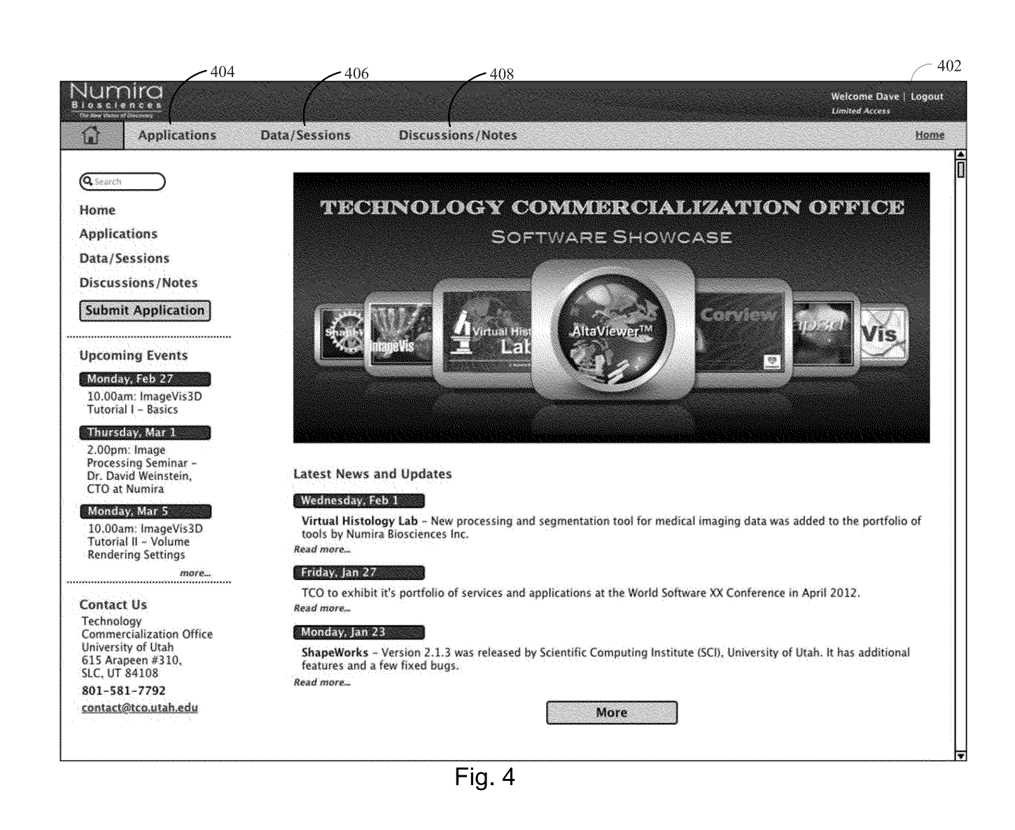

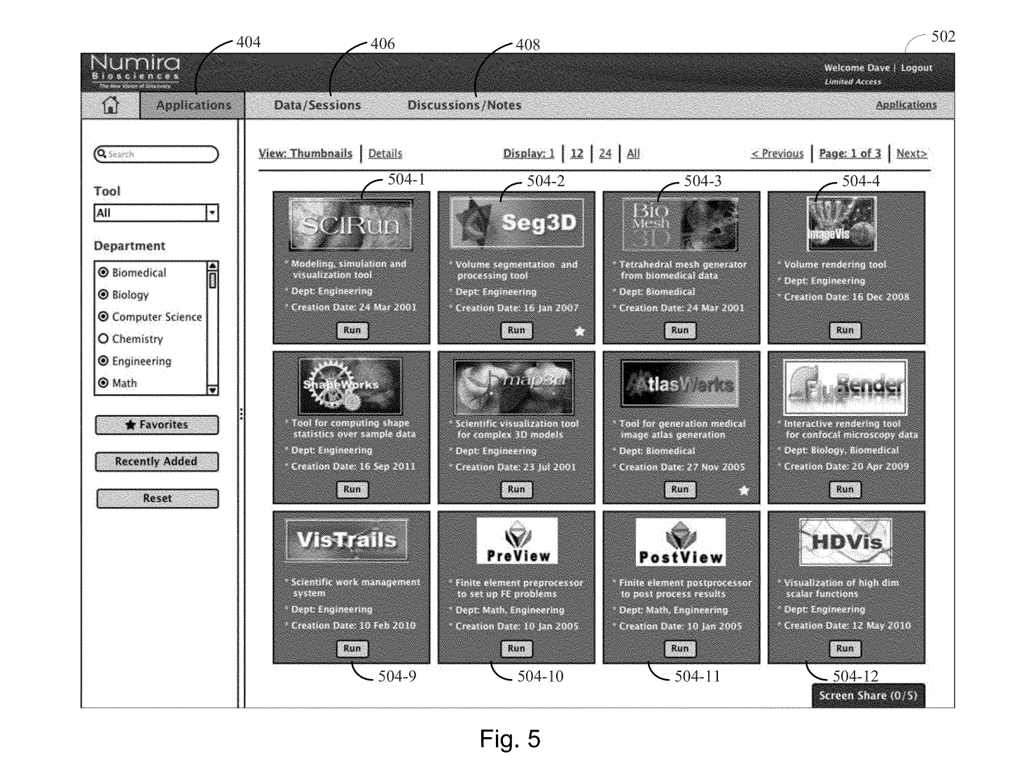

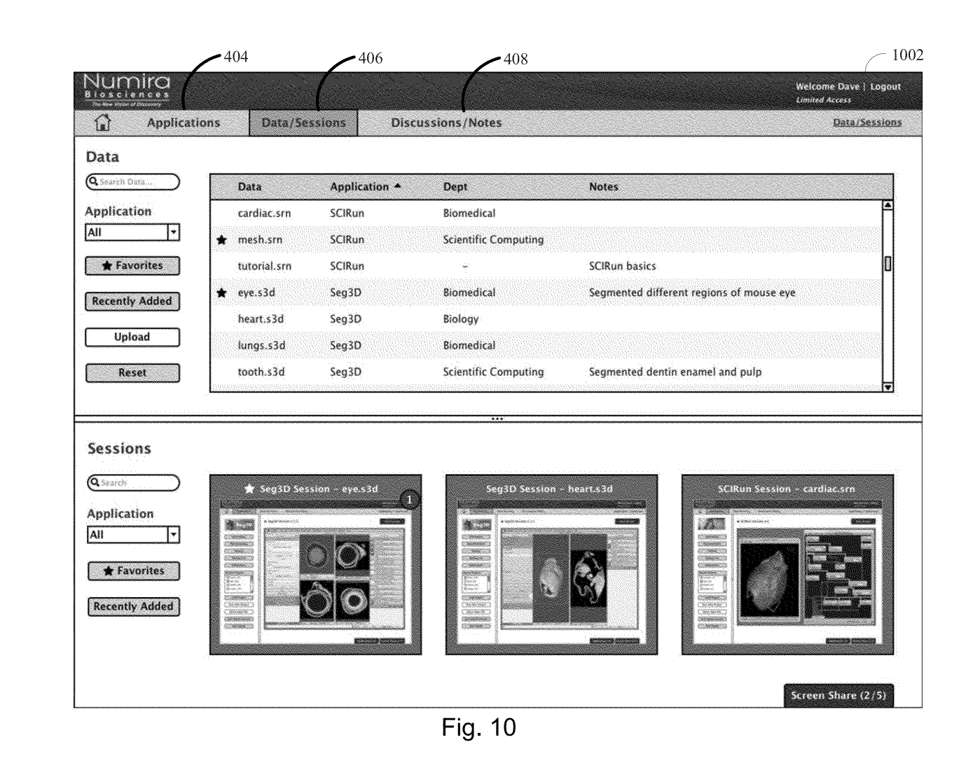

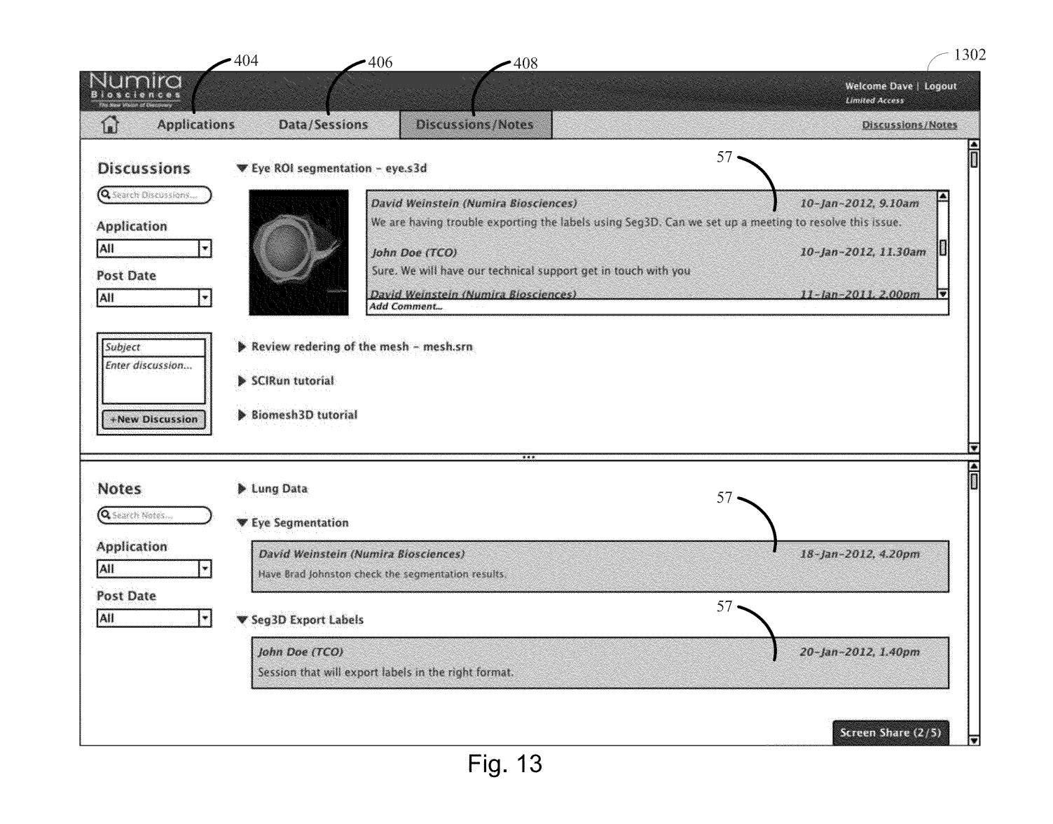

In some embodiments, each runtime system 46 comprises:
a login module 50 which provides a login page, an example of which is the login page 302 illustrated in FIG. 3;
a home page module 52 which provides a home page panel, an example of which is the home page panel 402 illustrated in FIG. 4;
an application module 54 which provides an application panel that includes a synopsis of each of the software applications that the host of the runtime system is presently offering and, when the user selects one such software application, the application panel provides more detail regarding the selected software application and allows the user to run the application, as exemplified by the application panel 502 illustrated in FIGS. 5-9, 11-12 and 14;
an annotation module 56 that allows a user to add annotations 57 to objects or software applications within the runtime system;
a data/sessions module 58 which provides a data/sessions panel that allows a user to review all of the data sets that the user has uploaded into the runtime system, thereby allowing the user to more easily try out the different data sets using the various software application available on the runtime system, the data/sessions panel further allowing the user to collect sessions, as exemplified by the data/sessions panel 1002 illustrated in FIG. 10;
a discussion/notes module 60 which provides a discussion/notes board for each user of the runtime system, the discussion/notes board tracking all the annotations made by a user on any object associated with the user including, but not limited to, uploaded data and instances of software applications that have been run by the user and saved as sessions; as exemplified by the discussion/notes board 1302 of FIG. 13;
a data/sessions module 62 that provides a data/sessions panel that allows a user to review all of the data sets that the user has uploaded into the runtime system, thereby allowing the user to more easily try out the different data sets using the various software application available on the runtime system, and the figure further illustrates how the user can collect sessions, where a session is created any time when a user is running an instance of the software applications offered on the runtime system and then terminates the instance in accordance with some embodiments of the present disclosure.
a user information module 62 which provides information about each user (client) 64 of the runtime system 46 including, for each user 64, a user profile 66 that includes the user's access credentials; and
a plurality of software applications and, for each respective software application 70, any combination of information such as documentation 72 for the respective software application 70, a tutorial 74 for the respective software application 70, a mailing list 76 of users interested in news and updates associated with the respective software application 70, publications 78 relating to the respective software application 70, and a link 80 to an installed instance of the respective application 70 which allows for the execution of the respective application 70 by users of the runtime system 46 in a virtual machine complete with any necessary components needed to run the respective software application 70.

As will be understood by one of skill in the art, there is individual nontransitory memory (e.g. of type 14) associated 1:1 with each virtual machine 42 residing on server 100. Such storage is where the virtual machine 42 operating systems and files are stored and accessed.

In practice, the hypervisor 40 initiates a virtual machine 42 on the server computer 100 and an operating system 44 is initiated within the initiated virtual machine 42. The hypervisor 40, also called a virtual machine manager (VMM), is any one of many hardware virtualization techniques that allow multiple operating systems 44 to run concurrently on the server computer 100. The hypervisor 40 presents to each of the guest operating systems 44 a virtual operating platform and manages the execution of such operating systems. Multiple instances of a variety of operating systems 44 may share the virtualized hardware resources. Commercial embodiments of the hypervisor 40 include, but are not limited to, OPENSTACK, EUCALYPTUS, VMWARE ESXI, CITRIX XENSERVER, MICROSOFT HYPER-V HYPERVISOR, SUN'S LOGICAL DOMAINS HYPERVISOR, and HP's INTEGRITY VIRTUAL MACHINES. Examples of operating systems 44 include, but are not limited to, UNIX, OPEN VMS, LINUX, and MICROSOFT WINDOWS. The runtime system 46 runs under the operating system 44 in a virtual machine 42.

Turning to FIG. 2, a local client system 200 will typically have one or more processing units (CPU's) 102, a network or other communications interface 104, a memory 114, a user interface 106 including a display 108 and keyboard 110, one or more communication busses 112 for interconnecting the aforementioned components, and a power supply 124 for powering the aforementioned components. The communication busses 112 may include circuitry (sometimes called a chipset) that interconnects and controls communications between system components. Memory 114 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 114 optionally includes one or more storage devices remotely located from the CPU(s) 2. Memory 114, or alternately the non-volatile memory device(s) within memory 114, comprises a non-transitory computer readable storage medium. Memory 114 can include mass storage that is remotely located with respect to the central processing unit(s) 102. In other words, some data stored in memory 114 may in fact be hosted on computers that are external to the local client system 200 but that can be electronically accessed by the client local system 200 over an Internet, intranet, or other form of network or electronic cable (illustrated as element 26 in FIG. 2) using network interface 104.

Memory 114 preferably stores an operating system 140 that includes procedures for handling various basic system services, a browser 142 for communicating with the runtime system 46, and user data 144 for uploading to the runtime system 46 and subsequent execution in software applications 70 to be evaluated

FIG. 2 further discloses one or more optional back-end servers 300. A back-end server 300 will typically have one or more processing units (CPU's) 202, a network or other communications interface 204, a memory 214, one or more communication busses 212 for interconnecting the aforementioned components, and a power supply 224 for powering the aforementioned components. The communication busses 212 may include circuitry (sometimes called a chipset) that interconnects and controls communications between system components. Memory 214 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 214 optionally includes one or more storage devices remotely located from the CPU(s) 2. Memory 214, or alternately the non-volatile memory device(s) within memory 214, comprises a non-transitory computer readable storage medium. Memory 214 can include mass storage that is remotely located with respect to the central processing unit(s) 202. In other words, some data stored in memory 214 may in fact be hosted on computers that are external to the back-end server 300 but that can be electronically accessed by the back-end server 300 over an Internet, intranet, or other form of network or electronic cable (illustrated as element 26 in FIG. 2) using network interface 204.

In some embodiments, the memory 214 stores an operating system 240 that includes procedures for handling various basic system services and a communication module 242 for connecting to remote computers, such as server 100, over network 26. In some embodiments, memory 114 further stores one or more application programs 244 that are remotely accessed and controlled by an instance of a runtime system 46. In some embodiments, application programs 244 are run within virtual machines that are optionally running on the back-end server 300.

Now that an overview of a system topology 10 in accordance with an aspect of the present disclosure has been described, more details of an exemplary runtime system 46 will be disclosed. There are numerous organizations that possess rights to software intellectual property portfolios. Such organizations can be, for example, technology commercialization offices at universities, intellectual property groups at larger corporations such as GOOGLE or MICROSOFT, and the like. As such, there's amount of software intellectual property at such organizations. Presently, it difficult for a user to find out who has this intellectual property and whether such intellectual property would be of value to the user. For instance, consider the case in which a user is interested in obtaining a faster, better search algorithm or something. There is no clear mechanism by which the user can even determine whether a particular organization, such as the University of Utah, has intellectual property relevant to this quest. The user may determine that someone at the University has published a paper on a relevant search algorithm, but there is no clear mechanism for taking this publication information and actually running test software that encodes the relevant search algorithm to see how well it performs. The instant runtime system 46 addresses this need.

Referring to FIG. 3, the login screen 302 for a runtime system 46 that facilitates software evaluation in a cloud computing environment is disclosed. Each user is associated with credentials. Thus, which aspects and functionality of the runtime system that the user will see when logged into the runtime system is completely dependent on the credentials associated with the user. For instance, in some instances the user has guest account that enables the user to see public information.

Referring to FIG. 4, after the user has logged in they are presented with homepage 402. This exemplary homepage represents an instance of the University of Utah technology commercialization offices' software showcase page. The homepage 402 shows upcoming events, the latest news and other updates. If the user selects the application toggle button 404 they are taken to the application panel 502 illustrated in FIG. 5.

Turning to FIG. 5, the application panel 502 is configured to show a brief synopsis 504 of each of the applications that the sponsor of the runtime system 46 is holding intellectual property on. As such, the application panel 502 is configured to provide a list of different applications that the sponsor of the runtime system 4, here the University of Utah technology commercialization offices, has. In this instance, the user is registered with the runtime system 46 with sufficient privileges to upload their own data sets to the runtime system when the user wants to try out these software products.

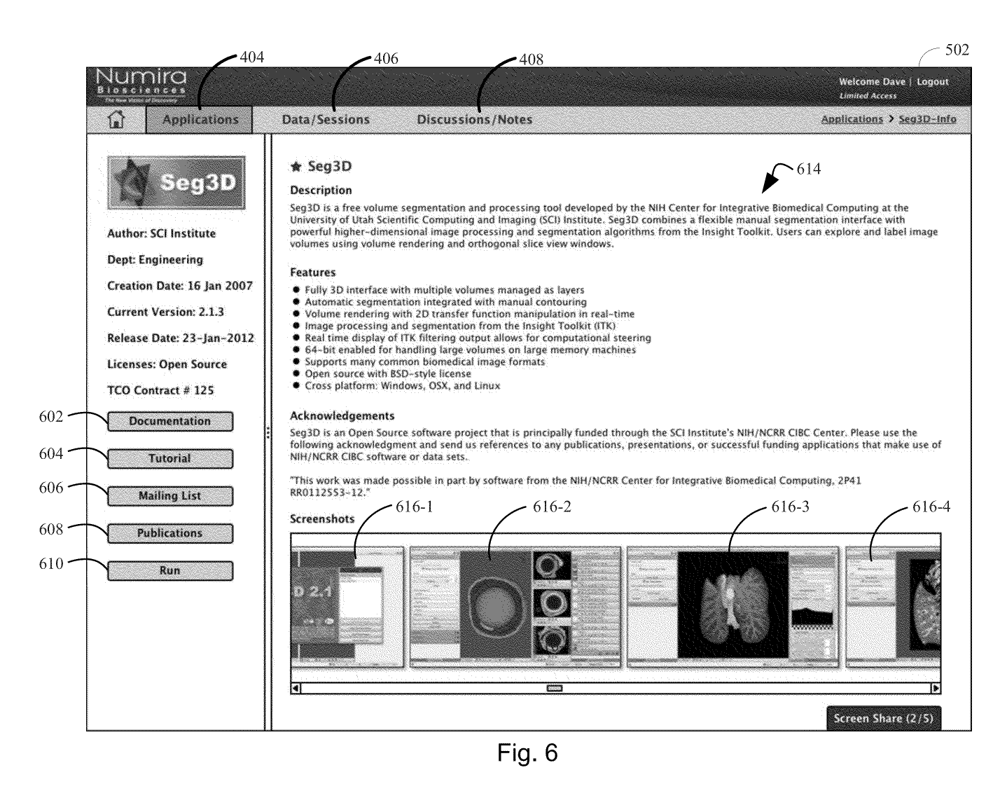

A user can select any respective synopsis 504 to find out more information about the software application 70 that corresponds to the respective synopsis. For example, in the example illustrated in FIG. 5, synopsis 504-2 is for the software application 70 “Seg3D”, a software tool for processing medical imaging data sets. When the user clicks on synopsis 404-2, it brings up a description of the software shown in FIG. 6. By clicking on tab 602, the user may obtain documentation information 72 for the selected software application 70. By clicking on tab 604, the user may obtain a tutorial 74 for the selected software application 70. By clicking on tab 606, the user may join a mailing list 76 for the selected software application 70 so that the user may receive news and updates associated with the respective software application 70. By clicking on tab 608, the user may obtain documentation publications 78 associated with or detailing the selected software application 70. By clicking on tab 610, the user can execute an installed instance of the respective software application 70 in, for example, within the same virtual machine 42 that the runtime system 46 is running in, a different virtual machine 42 that the runtime system 46 controls, or on a remote server 300.

As illustrated in FIG. 6, in some embodiments there is also information about the selected software application 70, for instance whether the selected software application 70 has been licensed, the University of Utah technology commercialization office contract number for the selected software application 70, and other related information. As further illustrated in FIG. 6, the features 614 and some snapshots 616 of the selected software application 70 being run are further shown.

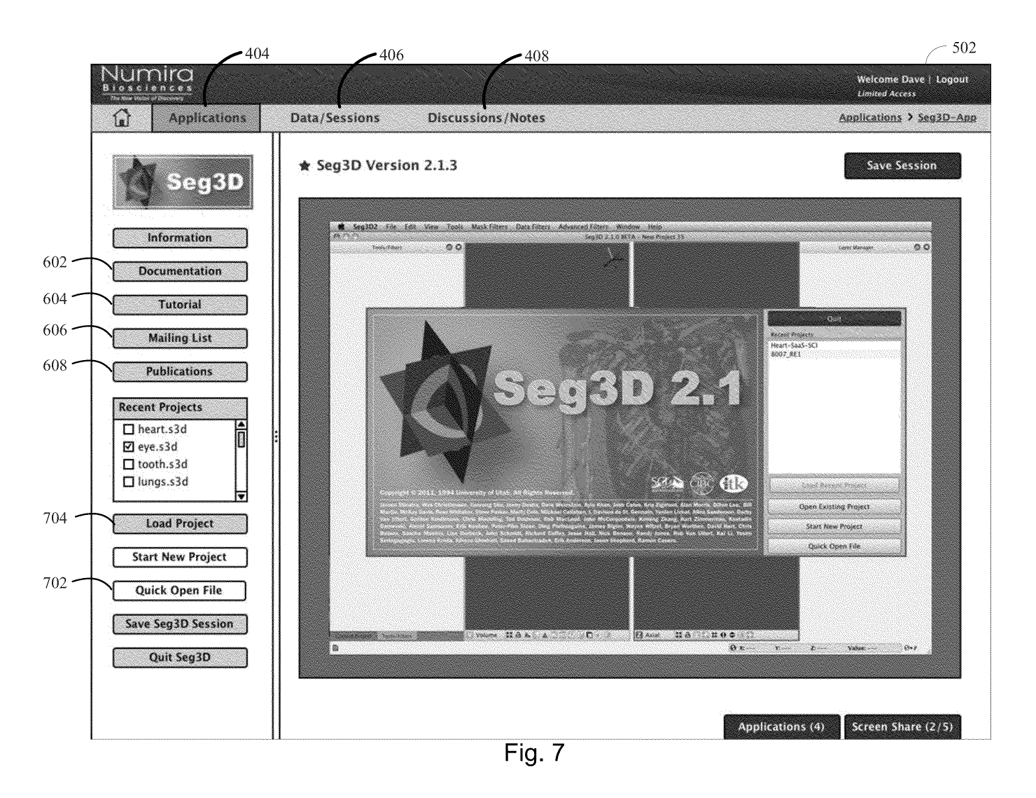

In some embodiments, as mentioned above, when a user clicks the “run” button 610, a version of the selected software application 70 is run in a virtual machine as illustrated in FIG. 7. The virtual machine could be the same virtual machine 42 that the runtime system 46 is running in, a different virtual machine 42 that the runtime system 46 controls, or on a remote server 300. The virtual machine could be the University of Utah's private virtual machine, or a third party vendor's virtual machine such as AMAZON or MICROSOFT or wherever the runtime system is configured to host instances of the software applications being showcased. Advantageously, there is no requirement that the selected software application 70 be run on the local system 200 associated with the user who has logged into the runtime system 46 through a browser window. With the respect to the user, the selected software application 70 is run remotely; typically in a cloud computing environment.

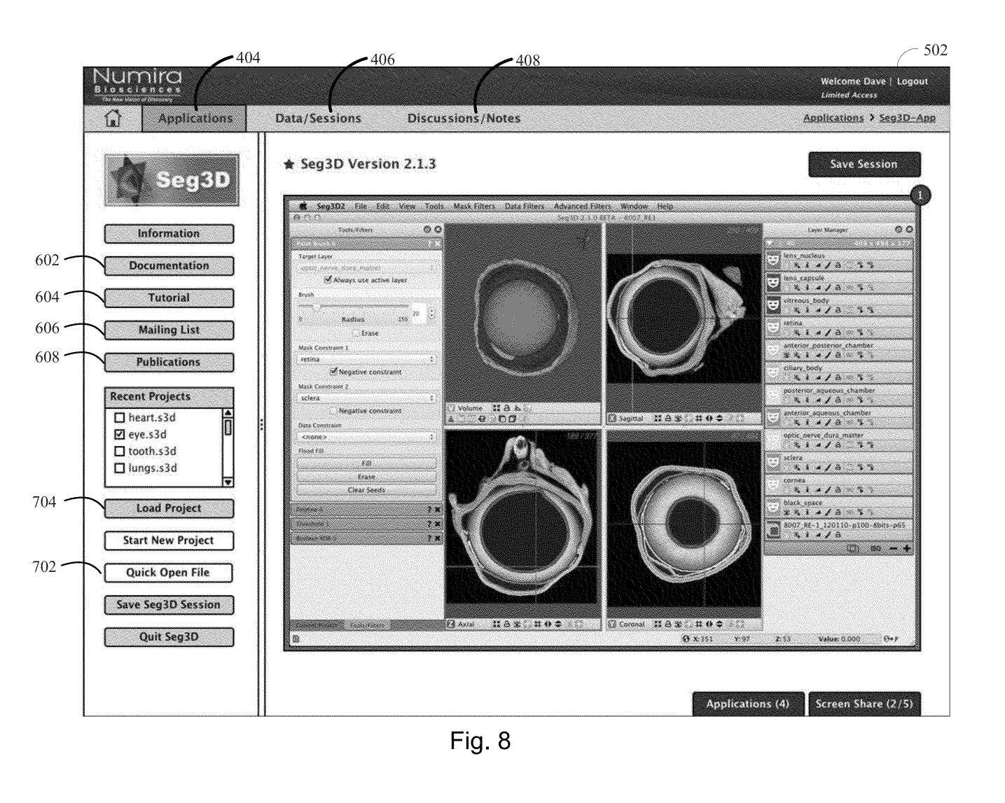

FIG. 7 illustrates the selected software program 70, Seg3D, being executed using the runtime system 46. In this example, the user is a subscriber of the runtime system 46. The user has a data set 144 (FIG. 2) suitable for the selected software application 70 being tested. The user uploads the dataset to the runtime system using, for example, the “Quick Open File” button 702. The user clicks on the load project button 704 thereby causing the runtime system to load in the data set and thus show how the Seg3D application can review segmentation of different portions of the eye, different labels within the eye, using the uploaded data, as illustrated in FIG. 8.

Referring to FIG. 8, the software program 70 (e.g., Seg3D) is run natively within the same virtual machine 42 that runtime system 46 is running in or on a back-end server 300 that is in electronic communication with the runtime system 42. Advantageously, the software application 70 is immediately set to the appropriate view. Depending on the use case, the appropriate view can be a view of the software application that was saved when the user last ran the software program or a view of the software application that was selected by the vendor of the software application. In some embodiments, the software application 70 is run in live box without any requirement that the software application 70 be installed on the user's local system 100. In other words, the visualization of the executed software application is controlled remotely from live box. Depending on the functionality provides by the software application 70, the user can rotate the data, zoom in and zoom out, import data and plot graphs. In some instances, a substantial amount of processing power and interactive visualization power is required to support the features of a software application 70. However, because of the advantageous way that the runtime system 46 is set up, such processing is done without any requirement that the user set up the software application on their local system 100. The runtime system 46 manages all of the calculations optionally using one or more back-end servers 200 that are in electronic communication with the runtime system 46. In some embodiments, instead of rendering images to a local display, the software application 70 renders output to an off screen buffer. That buffer is then sent out over a socket to a communicating application that is then reading in that buffer. This provides the advantage of providing an interface this is highly customized. In alternative embodiments, the software application 70 is run on the back-end server and the relevant portion of the screen that corresponds to that application is captured and sent out over a socket to a communicating application that is then reading in that buffer and displaying the output onto panel 502 as illustrated in FIG. 8. In some embodiments, the runtime system 46 in a first virtual machine 42 and the software application 70 that is being evaluated is running in a second virtual machine. In some embodiments, this second virtual machine is fired up when needed, for example, when the user selects a dormant instance of a software application 70, and then the second virtual machine shuts down when it is no longer needed, for example, because the user has terminated an instance of the software application 70 from within the runtime system 46.

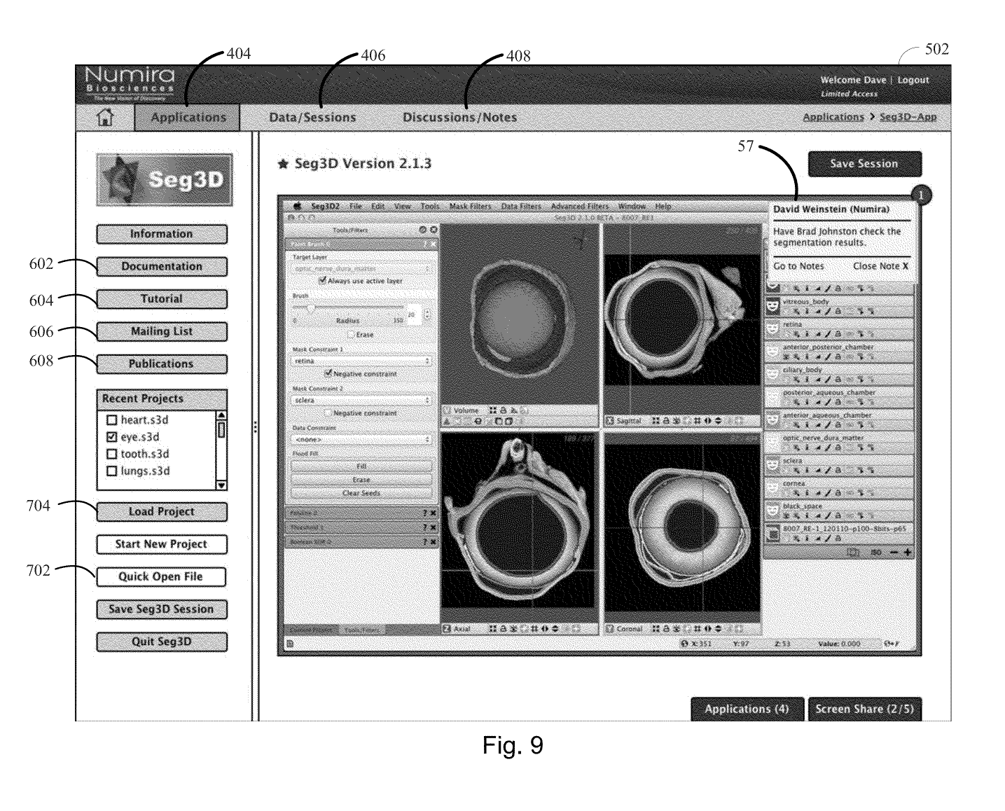

Further, as illustrated in FIG. 9, the runtime system 46 allows for the user to add annotation data 57. The annotation data is persistently stored by the runtime system 46, so that a user may retrieve the annotations in subsequent login sessions. In fact, in some embodiments, runtime system 46 tracks when such an annotation is created, a position and image size of the annotation, an identifier for the annotation, and for which instance of which software application 70 the annotation relates to. In this example, the user has left an annotation 57, in this case to remind the user to have a colleague check some of these segmentation results. As such, the runtime system 46 not only allows a user to test software without having to go through the trouble of installing it on their local computer system, they can associate annotations 57 with executed instances of the application software 70 being tested by the user. Moreover, referring to FIG. 13, the user can always go to the discussion/notes panel 1302 using tab 408 to see all annotations 57 in context that are associated with given test software applications 70.

The runtime system 46 provides access control associated with the all of the objects in the system. Accordingly, if a user uploads a new dataset 144 or creates an annotation 57, there will be some default permissions associated with the dataset 144 or annotation, where the default is that the user and the user's colleagues can see the dataset 144 or annotation 57 and the user can change these defaults. For instance, the user can change the permissions so that only the user creating an annotation 57 can see the annotations 57.

Referring to FIG. 10, the user can click on the data/sessions tab 406 to review all of the data sets that the user has uploaded into the runtime system 46. In this way, the user can more easily try out the different data sets using the various software applications 70 that are available on the runtime system 46. Moreover, the user can collect sessions. As used herein, a session is created any time when a user is running an instance of a software application 70 offered on the runtime system 46 and then terminates the instance. When this occurs, the final state of the instance of the software application 70 is saved and this final state is the session image. In some embodiments, the software application 70 is checkpointed just prior to termination so that, when the user selects a dormant instance of the software application 70 (e.g., by clicking on it), the session un-hibernates and an instance of the associated software program 70 is executed (e.g., in a virtual machine) beginning in the exact same state it was in when it was checkpointed and terminated, (e.g., the state shown in the session image).

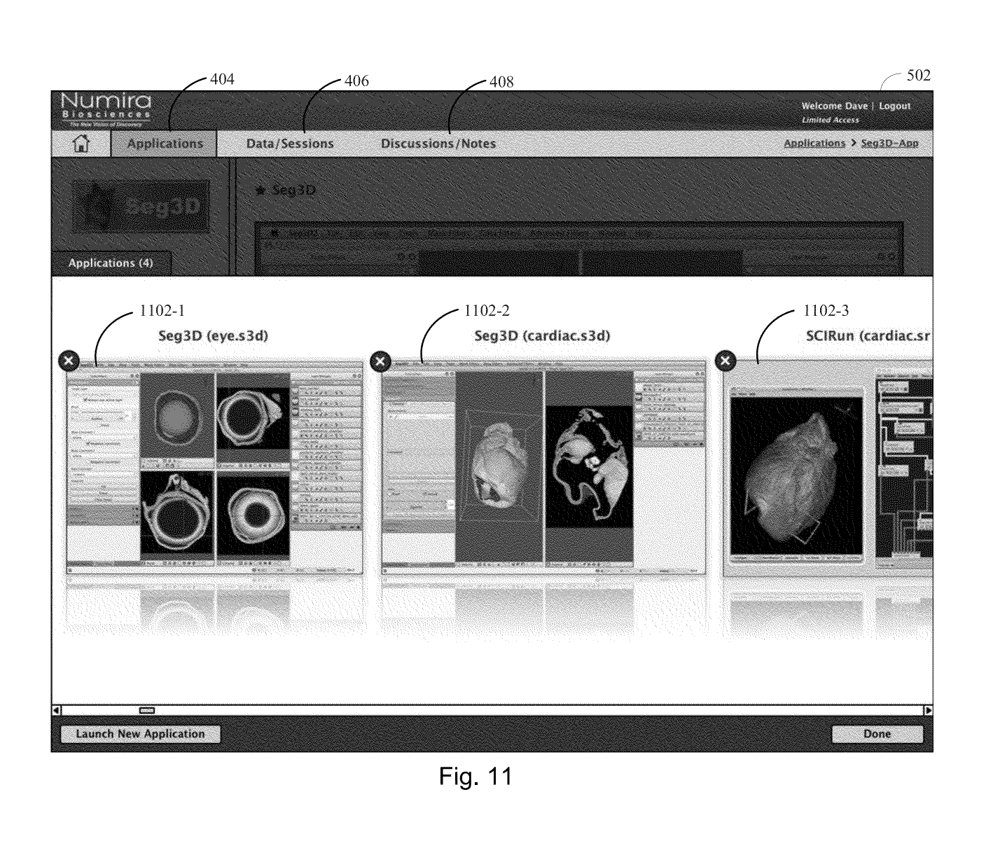

Referring to FIG. 11, at any particular moment, a user may have several instances 1102 of the software applications 70 executing using the runtime system 46. Using the application tab 404, the user can see each of these applications and scroll between them.

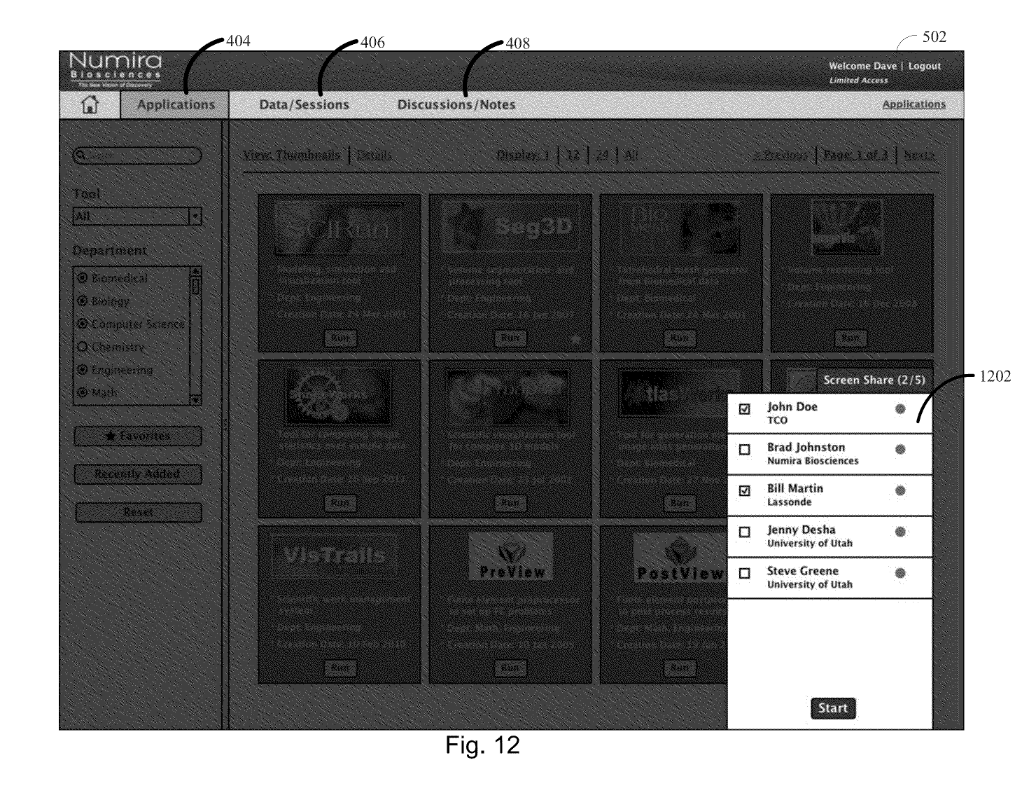

Referring to FIG. 12, a user can share the screen with other users that can log in to the runtime system 46. For instance, consider the case in which the user wants to evaluate the program Set3D with a colleague watching as well. The user can use menu 1202 to see who all is logged in, invite them then to share the user's screen and then start up the set3D software application. And then, as the user runs the software application, the colleague will be able to see the application on their own local computer system as well.

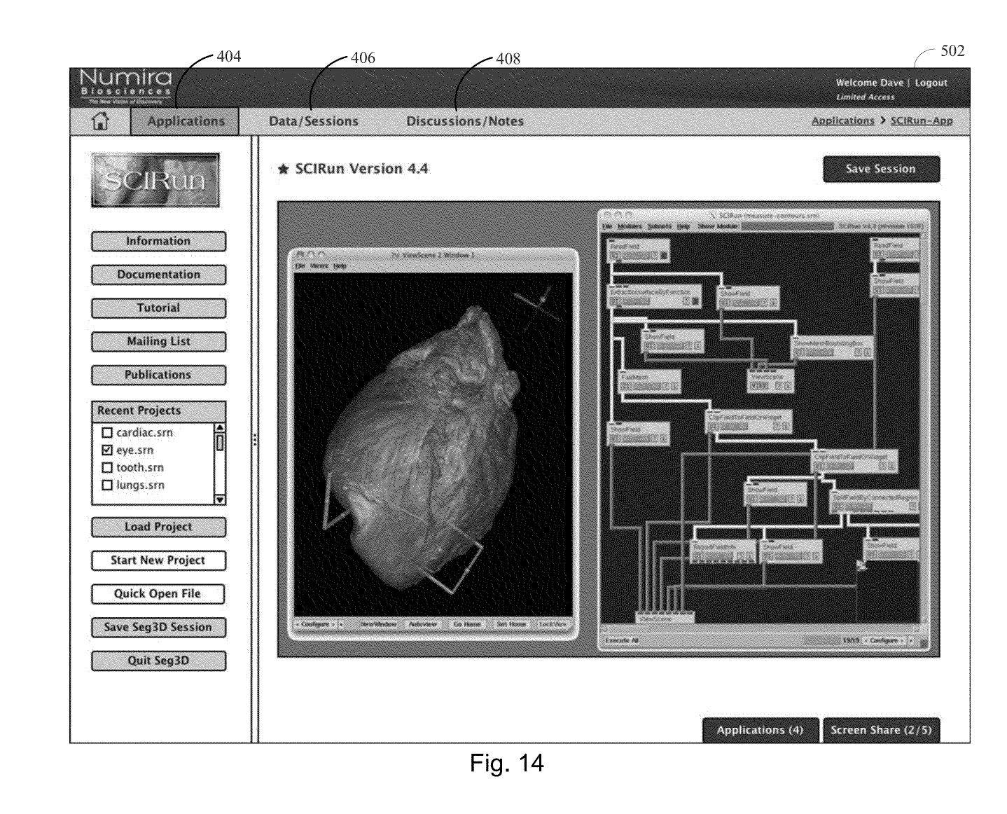

FIG. 14 illustrates another software program 70 that can be run using the runtime system, SciRun version 4.4. This program is executed when the user selects icon 504-1 on panel 502 illustrated in FIG. 5.

Advantageously, the runtime system 46 allows for a user to evaluate and run software applications 70 without having to install them on their local computer system 200. This is particularly beneficial in instances where the user does not have the correct hardware platform to run the software, the appropriate licenses to run libraries or other components required by the software, or does not have appropriate privileges on their local computer system 200 to install software. Moreover, the runtime system 46 obviates the need to engage in piracy prevention techniques because the user does not gain access to an executable form of the software.

### Exemplary Embodiments

In some implementations, a cloud based server computer system includes: one or more remotely located servers that store and run multiple software programs; at least one computer device capable of accessing the Internet; and an application accessible to multiple users through a user's internet web browser that allows for a user to access the multiple software programs without requiring the user to download any software program onto the user's computer; where the application is designed to facilitate a user's evaluation of the software programs.

In some implementations, the cloud based server computer system is configured to allow the user to upload test datasets to interact with the software programs.

In some implementations, in the cloud based server computer system described above, the application is accessible through the user's computer or mobile device capable of accessing the Internet.

In some implementations, the cloud based server computer system is configured to enable multiple users to access the same software programs concurrently.

In some implementations, a data storage and analysis cloud-based server computer system comprises: one or more remotely located servers that store a user's data and multiple software programs capable of processing and analyzing the data; at least one computer device capable of accessing the internet; and an application accessible to multiple users through a user's internet web browser that allows for a user's data stored on the remote server to be processed and analyzed using at least one software program stored on the remote server without requiring the user to download the data or any software program onto the user's computer.

In some implementations, the application allows at least two users to concurrently communicate, manipulate data, or visualize datasets.

In some implementations, the application allows for a user to login to the application using a unique login name and password associated with only one user.

In some implementations, the application associates data sets with a particular user based upon the unique login name and password provided by the user.

In some implementations, the application organizes a user's data into projects and a home page that provides details of a plurality of projects associated with a user.

In some implementations, the application further comprises an overview panel for a project selected from the plurality of projects.

In some implementations, the application further comprises a data analysis panel for the selected project, the data analysis panel comprising a plurality of measurements for each sample in the plurality of samples associated with the project.

In some implementations, the application further comprises a visual analysis panel for the selected project, the visual analysis panel including a plurality of objects associated with the selected project.

In some implementations, the application further comprises a gallery panel for the selected project, for reviewing content that is associated with the selected project.

In some implementations, the application further comprises a live meeting panel for a selected project, where the live meeting panel comprises a whiteboard that is configured to be viewed by any user associated with the selected project, and where any user associated with the project that is viewing the whiteboard can drag objects associated with the selected project onto the whiteboard and can annotate the whiteboard.

In some implementations, the application further comprises a real time tracking system to track the status of samples being processed by the first user.

In some implementations, the data comprises volumetric imaging datasets that can be viewed in both two-dimensional and three-dimensional visualizations using at least one software program stored on the remotely located servers.

In some implementations, the application allows for the user to interact and view the data through a desktop computer or a mobile device.

In some implementations, the application allows for the user to select multiple data inputs and view the data in side-by-side comparison.

In some implementations, the server computer system further comprises metadata tags to encode information about how a project dataset was created.

In some implementations, the application allows for the user to input annotations that are saved on the remotely located servers.

In other implementations, a collaborative, cloud-based data storage and analysis system comprises: one or more remotely located servers that store a user's data and multiple software programs capable of processing and analyzing the data; at least one computer device capable of accessing the internet; an application accessible to multiple users through a user's internet web browser that allows for a user's data stored on the remote server to be processed and analyzed using at least one software program stored on the remote server without requiring the user to download the data or any software program onto the user's computer; where the application tightly couples the software programs as needed by the user for seamless integration; where the application can be accessed by multiple users simultaneously; where the application facilitates computing derived values from the original data; where the application facilitates exploration and analysis of the data; where the application can be accessed using various operating systems; and where the user's data can be searched or filtered by the application.

In some implementations, the application further comprises any combination of two or more of features (i) through (iv): (i) the application tracks which user accesses the data and records the time and date of access; (ii) the application records and stores provenance data, which encodes the applications and parameters that were used in creating a dataset; (iii) the application comprises an electronic laboratory notebook for the user to store data, computations, annotations, or communications; and (iv) multiple users of the system can collaboratively explore data together in real time.

In some implementations, the application further comprises all of the following features: (i) the application tracks which user accesses the data and records the time and date of access; (ii) the application records and stores provenance data, which encodes the applications and parameters that were used in creating a dataset; (iii) the application comprises an electronic laboratory notebook for the user to store data, computations, annotations, or communications; and (iv) multiple users of the system can collaboratively explore data together in real time.

In some implementations, the collaborative, cloud-based data storage and analysis is used in a scientific or engineering industry.

In some implementations, the collaborative, cloud-based data storage and analysis is used in the life scientific industry.

In some implementations, the collaborative, cloud-based data storage and analysis is used for preclinical pharmaceutical development.

In some implementations, the collaborative, cloud-based data storage and analysis is used for medical device development.

### References Cited and Alternative Embodiments

All references cited herein are incorporated herein by reference in their entirety and for all purposes to the same extent as if each individual publication or patent or patent application was specifically and individually indicated to be incorporated by reference in its entirety for all purposes.

The embodiments disclosed herein can be implemented as a computer program product that comprises a computer program mechanism embedded in a tangible computer readable storage medium. For instance, the computer program product could contain the program modules shown in FIGS. 1 and/or 2. These program modules can be stored on a CD-ROM, DVD, magnetic disk storage product, or any other nontransitory computer readable data or program storage product.

Many modifications and variations of the embodiments disclosed herein can be made without departing from its spirit and scope, as will be apparent to those skilled in the art. The specific embodiments described herein are offered by way of example only. The embodiments were chosen and described in order to best explain the principles of the present disclosure and its practical applications, to thereby enable others skilled in the art to best utilize the present disclosure and various embodiments with various modifications as are suited to the particular use contemplated. The present disclosure is to be limited only by the terms of the appended claims, along with the full scope of equivalents to which such claims are entitled.

What is claimed:

1. A method, comprising:
at a computer system,
maintaining session information for a plurality of remote user sessions between one or more users and the computer system;
formatting for display a plurality of graphical representations corresponding to the plurality of remote user sessions, wherein a respective graphical representation in the plurality of graphical representations indicates an active or historical state of a corresponding remote user session in the plurality of remote user sessions;
obtaining a user selection of a graphical representation in the plurality of graphical representations from a user; and
in response to the user selection of the graphical representation;
establishing a session between a client device associated with the user and the computer system; and
beginning the session in the active or historical state as indicated in the graphical representation.

2. The method of claim 1, further comprising: enabling the user to execute a software application in a plurality of software applications hosted at the computer system within a virtual machine associated with the computer system.

3. The method of claim 1, wherein a respective graphical representation in the plurality of graphical representations represents a state of the corresponding session when the corresponding session was terminated.

4. The method of claim 1, wherein a respective graphical representation in the plurality of graphical representations represents a state of the corresponding session when the corresponding session was last checkpointed.

5. The method of claim 1, further comprising: preparing for display a user interface control configured to upload data sets from the client device associated with the user for execution in a remote user session in the plurality of remote user sessions.

6. The method of claim 1, further comprising: preparing for display information identifying one or more data sets that the user has uploaded onto the computer system.

7. The method of claim 1, further comprising: preparing for display a user interface control configured to upload data sets from the client device associated with the user for execution in a remote user session in the plurality of remote user sessions.

8. The method of claim 1, further comprising: preparing for display an authentication module configured to authenticate the user before enabling the user to log in to the computer system.

9. The method of claim 1, further comprising: preparing for display an annotation module configured to enable the user to add annotations to an object or an instance of a software application in a plurality of software applications hosted at the computer system.

10. The method of claim 1, further comprising: preparing for display an annotation tracking module configure to enable the user to track one or more annotations made by the user to an instance of a software application in the plurality of software applications.

11. The method of claim 1, further comprising: preparing for display a synopsis of a software application in a plurality of software applications hosted by the computer system.

12. A computer system comprising:
one or more processing units;
one or more programs including instructions, configured to be executed by the one or more processing units, for:
maintaining session information for a plurality of remote user sessions between one or more users and the computer system;
formatting for display a plurality of graphical representations corresponding to the plurality of remote user sessions, wherein a respective graphical representation in the plurality of graphical representations indicates an active or historical state of a corresponding remote user session in the plurality of remote user sessions;
obtaining a user selection of a graphical representation in the plurality of graphical representations from a user; and
in response to the user selection of the graphical representation;
establishing a session between a client device associated with the user and the computer system; and
beginning the session in the state as indicated in the graphical representation.

13. The system of claim 12, wherein the one or more programs further comprise instructions for enabling the user to execute a software application in a plurality of software applications hosted at the computer system within a virtual machine associated with the computer system.

14. The system of claim 12, wherein a respective graphical representation in the plurality of graphical representations represents a state of the corresponding session when the corresponding session was terminated.

15. The system of claim 12, wherein a respective graphical representation in the plurality of graphical representations represents a state of the corresponding session when the corresponding session was last checkpointed.

16. The system of claim 12, wherein the one or more programs further comprise instructions for preparing for display a user interface control configured to upload data sets from the client device associated with the user for execution in a remote user session in the plurality of remote user sessions.

17. The system of claim 12, wherein the one or more programs further comprise instructions for preparing for display information identifying one or more data sets that the user has uploaded onto the computer system.

18. The system of claim 12, wherein the one or more programs further comprise instructions for preparing for display a user interface control configured to upload data sets from the client device associated with the user for execution in a remote user session in the plurality of remote user sessions.

19. The system of claim 12, wherein the one or more programs further comprise instructions for preparing for display an authentication module configured to authenticate the user before enabling the user to log in to the computer system.

20. The system of claim 12, wherein the one or more programs further comprise instructions for preparing for display an annotation module configured to enable the user to add annotations to an object or an instance of a software application in a plurality of software applications hosted at the computer system.

21. The system of claim 12, wherein the one or more programs further comprise instructions for preparing for display an annotation tracking module configured to enable the user to track one or more annotations made by the user to an instance of a software application in the plurality of software applications.

22. The system of claim 12, wherein the one or more programs further comprise instructions for preparing for display a synopsis of a software application in a plurality of software applications hosted by the computer system.

23. A non-transitory computer readable storage medium storing one or more programs, the one or more programs comprising instructions, configured to be executed by a computer system with one or more processors, for:
maintaining session information for a plurality of remote user sessions between one or more users and the computer system;
formatting for display a plurality of graphical representations corresponding to the plurality of remote user sessions, wherein a respective graphical representation in the plurality of graphical representations indicates a current or historical state of a corresponding remote user session in the plurality of remote user sessions;
obtaining a user selection of a graphical representation in the plurality of graphical representations by a user; and
in response to the user selection of the graphical representation;
establishing a session between a client device associated with the user and the computer system; and
beginning the session in the state as indicated in the graphical representation.

24. The non-transitory computer readable storage medium of claim 24, wherein the one or more programs further comprise instructions for enabling the user to execute a software application in a plurality of software applications hosted at the computer system within a virtual machine associated with the computer system.

25. The non-transitory computer readable storage medium of claim 24, wherein a respective graphical representation in the plurality of graphical representations represents a state of the corresponding session when the corresponding session was terminated.

26. The non-transitory computer readable storage medium of claim 24, wherein a respective graphical representation in the plurality of graphical representations represents a state of the corresponding session when the corresponding session was last checkpointed.

27. The non-transitory computer readable storage medium of claim 24, wherein the one or more programs further comprise instructions for preparing for display a user interface control configured to upload data sets from the client device associated with the user for execution in a remote user session in the plurality of remote user sessions.

28. The non-transitory computer readable storage medium of claim 24, wherein the one or more programs further comprise instructions for preparing for display information identifying one or more data sets that the user has uploaded onto the computer system.

29. The non-transitory computer readable storage medium of claim 24, wherein the one or more programs further comprise instructions for preparing for display a user interface control configured to upload data sets from the client device associated with the user for execution in a remote user session in the plurality of remote user sessions.

30. The non-transitory computer readable storage medium of claim 24, wherein the one or more programs further comprise instructions for preparing for display an authentication module configured to authenticate a user before enabling the user to log in to the computer system.

31. The system of claim 12, wherein the one or more programs further comprise instructions for preparing for display an annotation module configured to enable the user to add annotations to an object or an instance of a software application in a plurality of software applications hosted at the computer system.

32. The non-transitory computer readable storage medium of claim 24, wherein the one or more programs further comprise instructions for preparing for display an annotation tracking module configure to enable the user to track one or more annotations made by the user to an instance of a software application in the plurality of software applications.

33. The non-transitory computer readable storage medium of claim 24, wherein the one or more programs further comprise instructions for: preparing for display a synopsis of a software application in a plurality of software applications hosted by the computer system.
